(19) United States
(12) Patent Application Publication
(10) Pub. No.: US 2007/0234723 A1
(43) Pub. Date: Oct. 11, 2007

(54) Device and method for converting gravitational force to energy

(76) Inventor: Steven W. Elliott, Richmond, VA (US)

Correspondence Address: John B. Hardaway, III;NEXSEN PRUET, LLC, P.O. Box 10107, Greenville, SC, 29603, US

(21) Appl. No.: 11/447,205

(22) Filed: Jun. 5, 2006

Related U.S. Application Data
(63) Continuation-in-part of application No. 10/457,602, filed on Jun. 9, 2003.

(51) Int. Cl. F03G 7/00

(52) U.S. Cl. 60/721; 415/916

(57) ABSTRACT

A device for converting gravitational force to energy. The device comprises a rotor (1). The rotor comprises a first outer chamber (4), a second outer chamber (5), and a casing (40). A piston (3) is slidably received in the casing between the first outer chamber (4) and the second outer chamber (5), above the first outer chamber. When the piston slides in the casing towards the first outer chamber, displacement fluid (7) exits the first outer chamber and enters the second outer chamber, thereby causing the second outer chamber to be heavier than the first outer chamber. A pivot (12) is provided wherein the rotor (1) can rotate such that the second outer chamber becomes lower than the first outer chamber. A shaft (14) is provided which is parallel to the pivot and capable of rotating with the rotor. A generator (15) is coupled to the shaft.

### BACKGROUND OF THE INVENTION

The present invention relates to a device, and method, for converting gravitational force to usable energy. More specifically, the present invention relates to a device, and method, for converting gravitational energy to rotational energy whereby the rotational energy can be harnessed for beneficial purposes with high efficiency.

Energy generation is vital to the survival and advancement of civilization. There is a continual desire to harness energy from non-depletable resources such as wind, tidal fluctuations and gravitational force. This desire will continue until the use of depletable resources, such as fossil fuels, is substantially reduced.

Harnessing energy from tidal fluctuations has been explored for many years. This method is limited by proximity to an ocean and by the corrosive nature of seawater. It is apparent to those of skill in the art that reducing mechanical losses, such as friction, is critical to efficient energy conversion. The corrosive nature of seawater is contrary to this desire.

The use of wind energy is widely used. This method is limited by the variability of wind. The unpredictable nature of wind requires that any wind based energy generation system have a supplemental energy source. With high winds a wind based energy generation system must be able to respond to the wind, typically by rotation, without generating the maximum amount of power. This is often referred to in the art as spilling. This non-energy producing rotation causes the various components to wear unnecessarily.

Harnessing energy from gravitational pull would be of great advantage. Gravitational pull is relatively constant at all times and in all conditions. This would allow energy generation systems to be virtually universal without regard for terrain, weather, or other uncontrollable events such as those related to geography and political systems. Harnessing gravitational pull would greatly benefit mankind.

Attempts to capture gravitational pull have met with limited success. Unbalanced rotating systems are described in U.S. Pat. Nos. 6,363,804; 5,921,133 and 4,333,548. The large number of moving parts and engaged gears reduces the efficiency of these systems. It is a desire to reduce the number of moving parts to increase efficiency of the overall system. A system based on fluid flow is described in U.S. Pat. No. 3,028,727. A method utilizing a threaded rod turned by a descending weight is described in U.S. Pat. No. 6,220,394. U.S. Pat. No. 4,509,329 does not describe displacement of fluid between cavities.

A system is described by Elliott in U.S. Pat. Publ. No. 2004/0247459. This system has shown great promise as a system for transferring gravitation to energy. This advance has led to the realization that further improvements in the efficiencies would provide even greater opportunity for widespread use as an alternate energy source.

It has been an ongoing desire to harness gravitational forces efficiently. This goal has been achieved with the present invention.

### BRIEF SUMMARY OF THE INVENTION

It is an object of the present invention to provide a method of harnessing energy from gravity.

It is another object of the present invention to harness energy efficiently and without the necessity for auxiliary power.

A particular feature of the present invention is the simplicity of the inventive device and the minimal number of moving parts required to achieve the stated objects.

Another particular feature is the ability to utilize the present invention in any location without regard for geography or environmental concerns.

Another feature of the present invention is the improvement in overall efficiency of the system with regards to the amount of energy generated by rotation.

These and other advantages, as will be realized, are provided in a device for converting gravitational force to energy. The device has a rotor with an axis of rotation as well as an upper portion and a lower portion. The rotor also has a casing, a lower cavity and an upper cavity in flow communication with the lower cavity. A piston is provided with a first lobe and a second lobe wherein the first lobe and the second lobe are displaced in opposite directions from a center of mass of the piston and wherein the piston is slidably received in the casing and between the lower cavity and upper cavity wherein when the piston slides in the casing towards the lower cavity displacement fluid is forced from the lower cavity to the upper cavity thereby causing the upper cavity to be heavier than the lower cavity. The rotor can rotate on the axis of rotation such that the upper cavity becomes lower than the lower cavity to generate power.

Another embodiment is provided in a device for converting gravitational force to energy. The device has a rotor with an axis of rotation wherein the rotor comprises a first end, a second end, a first cavity in the first end and a second cavity in the second end wherein the second cavity is in flow communication with the first cavity. A piston is provided between the first cavity and the second cavity wherein when the piston slides in response to gravity towards the first end a displacement fluid exits the first cavity and enters the second cavity thereby causing the rotor to be heavier on the second end. A pivot is provided wherein the rotor can rotate on the pivot such that the second end rotates to a position lower than the first end in response to gravity. When the piston slides the movement is in a direction which is not co-linear with gravity. A shaft is provided which is capable of rotating with the rotor. A generator is coupled to the shaft.

Yet another embodiment is provided in a rotor with an offset center of balance for converting gravitational force to rotational energy. The rotor has a first end and a second end with a first cavity in the first end and a second cavity in the second end. The second cavity is in flow communication with the first cavity. A central pivot point is provided between the first end and the second end. A piston is between the first end and the second end wherein the piston moves between the first end and the second end. The piston center of gravity and the rotor center of gravity move in a direction which is not co-linear with the force of gravity. A shaft is provided which is parallel to the central pivot.

Yet another embodiment is provided in a device for generating energy from gravitational pull. The device has a casing with a rotational axis, a first offset cavity and a second offset cavity wherein the first offset cavity and the second offset cavity are offset separately relative to the rotational axis. A piston is provided which is slidably attached inside the casing and capable of sliding due to gravity. A displacement fluid is provided which is capable of moving between the first offset cavity and the second offset cavity as the piston slides within the casing.

Yet another embodiment is provided in a rotor for converting gravitational force to rotational energy. The rotor has a first end and a second end. A first cavity is in the first end. A second cavity is in the second end wherein the second cavity is in flow communication with the first cavity. A displacement fluid is provided which is selectively in the first cavity or the second cavity. A central pivot point is provided between the first end and the second end. A piston is provided wherein when the piston moves in response to the force of gravity a center of mass of the displacement fluid moves from the first cavity to second cavity in a direction which is not co-linear with the force of gravity.

### BRIEF DESCRIPTION OF THE DRAWINGS

FIG. 1 is a cross-sectional view of an embodiment of the present invention prior to the response to gravity.

FIG. 2 is a cross-sectional view of the embodiment of FIG. 1 after the response to gravity and prior to conversion of the response to energy.

FIG. 3 is a schematic representation of a single rotor coupled to a generator.

FIG. 4 is a schematic representation of an embodiment of the present invention wherein multiple devices are coupled sequentially to a generator.

FIG. 5 is a cross-sectional view of an embodiment of the present invention.

FIG. 6 is a cross-sectional view of a drive mechanism of one embodiment of the present invention.

FIG. 7 is a cross-sectional view of a preferred rotor of the present invention.

FIG. 8 is a cross-sectional view of a preferred rotor of the present invention.

FIG. 9 is a perspective view of a preferred rotor of the present invention.

FIG. 10 is a schematic representation of a system of the present invention.

FIG. 11 is a schematic representation of a system of the present invention.

FIG. 12 is a schematic representation of a preferred embodiment of the present invention.

FIG. 13 is a schematic representation of an embodiment of the present invention after rotation and prior to mass transfer due to gravity.

FIG. 14 is a schematic representation of the embodiment of claim 12 after mass transfer due to gravity.

FIG. 15 is a diagrammatic representation of an embodiment of the present invention.

FIG. 16 is a partial cut-away view of a preferred embodiment of the present invention.

FIG. 17 is a side-cross-sectional partial view of the embodiment of claim 16.

### DETAILED DESCRIPTION OF THE INVENTION

The inventor of the present application has developed, through diligent research, a device capable of efficiently harnessing energy from gravitational pull. The inventor has also developed a method for incorporating such an inventive device in a system for generating energy from gravitational pull.

The invention will be described with reference to the figures forming a part of the present application. In the various figures similar elements are numbered accordingly.

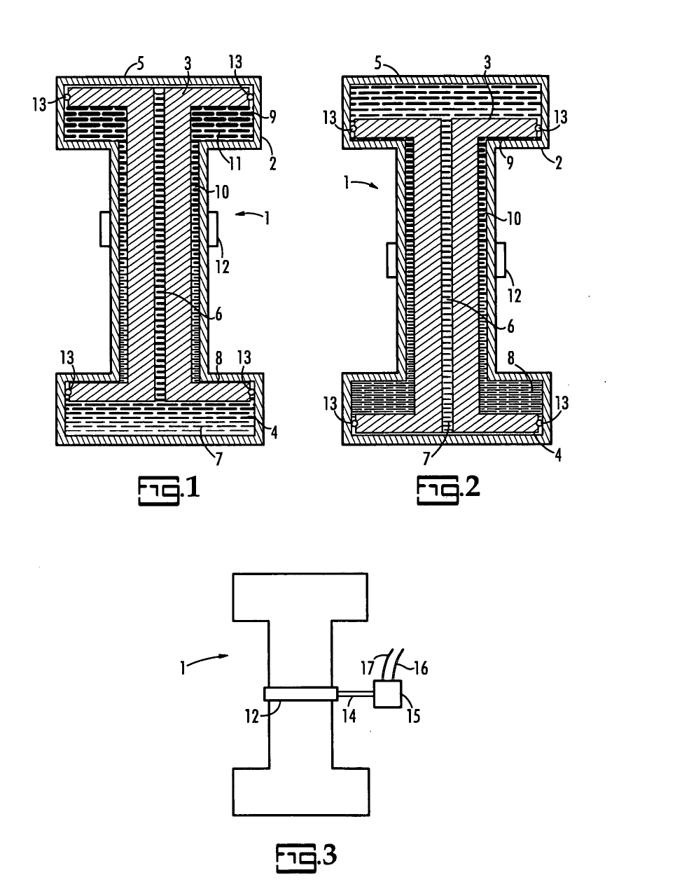

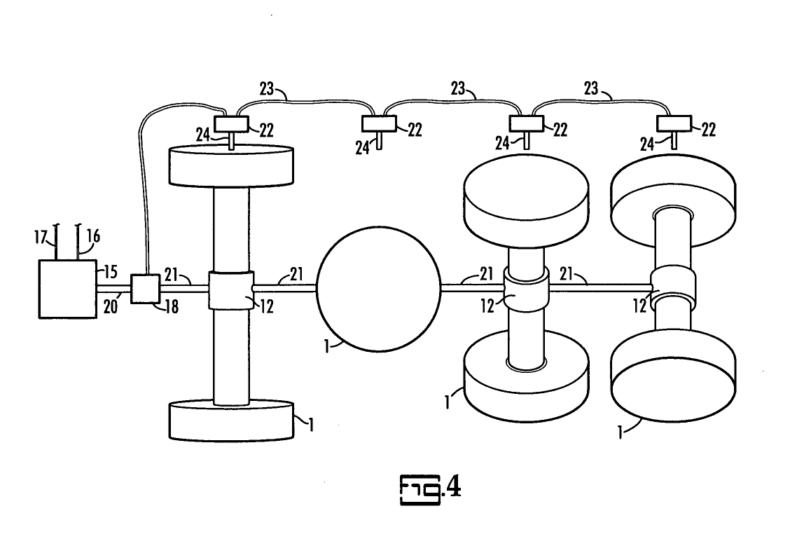

A cross-sectional view of an, embodiment of the present invention is provided, and will be described with reference to, FIGS. 1 and 2. FIG. 1 illustrates an embodiment of the present invention prior to the response to gravitational pull. For the sake of clarity gravitational force will be in the direction of the bottom of each figure.

In FIG. 1, the rotor, generally represented at 1, comprises an outer shell, 2, and an inner piston, 3. The piston is slidably displaceable within the outer shell. Between the outer shell and piston are variable chambers with select pairs having correlated volumes. A pair of outer chambers, 4 and 5, are connected via a transport column, 6. An outer displacement fluid, 7, freely moves between the first outer chamber, 4, and second outer chamber, 5, through the transport column, 6. A pair of inner chambers, 8 and 9, are connected via a flow channel between the first inner chamber, 8, and second inner chamber, 9. A counter fluid, 11, freely moves between the first inner chamber, 8, and second inner chamber, 9, via a flow channel, 10. The displacement fluid has a higher density than that of the counter fluid.

In the orientation illustrated in FIG. 1, the rotor has the first outer chamber, 4, filled with displacement fluid while the second inner chamber, 9, is filled with counter fluid. Due to gravitational pull the piston will move downward causing displacement fluid to move from the first outer chamber, 4, through the transport column, 6, to the second outer chamber, 5. When the piston has moved to its furthest extent downward, as illustrated in FIG. 2, the second outer chamber, 5, contains displacement fluid while the second inner chamber is essentially collapsed. The first outer chamber, 4, is essentially collapsed and the first inner chamber, 8, contains counter fluid as shown in FIG. 2. Due to the higher density of the displacement fluid relative to the counter fluid the rotor is heavier at the top than at the bottom. By allowing free rotation the rotor will naturally turn around a centrally located couple, 12. Upon reaching the fully inverted position the configuration illustrated in FIG. 1 is re-established with the first inner chamber and first outer chamber on the top.

The inner chambers are in flow communication with each other and the outer chambers are in flow communication with each other. It would be apparent that the inner chambers are not in flow communication with the outer chambers. An optional, but preferred, seal, 13, is provided to separate the inner chambers from the outer chambers. The seal may be a ring around the piston as commonly employed for separating chambers above and below a piston.

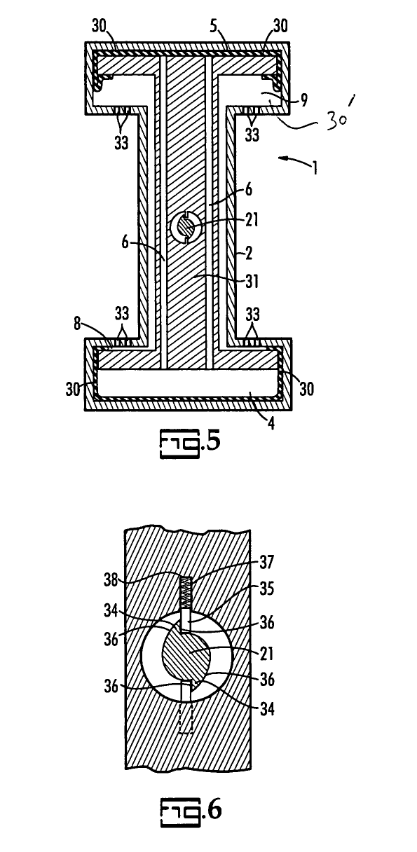

An embodiment of the present invention is further described in reference to FIG. 3. The rotor, 1, and collar, 12, as described previously, are attached to a drive shaft, 14, which rotates in correlation with the rotation of the rotor. The drive shaft, 14, is in turn coupled to a generator, 15, which generates energy in response to the rotation of a shaft coupled thereto. Leads, 16 and 17, transport the energy to a location of choice.

A system utilizing the present invention is provided in FIG. 4. In FIG. 4, a multiplicity of rotors, 1, are arranged inline linearly and attached to a generator, 15. The generator transports energy through leads, 16 and 17. Each rotor, 1, is preferably in a different rotational orientation from at least one other rotor. A secondary drive shaft, 20, transfers the rotational motion from the assembly of rotors to the generator. An optional, but preferred, shaft intermediate, 18, is provided. The shaft intermediate, 18, may comprise a slip clutch whereby rotation of the primary drive shaft, 21, is only correlated in one rotational direction with the opposite rotation being free rotation. The primary drive shaft, 21, may be a continuous shaft passing through the series of rotors, 1, or a series of shafts with each shaft transferring rotational energy to the next shaft in the series towards the generator. The primary drive shaft, 21, and secondary drive shaft, 20, may be a continuous shaft.

The number of rotors in a series is dependent on the size of each rotor and the cycle time required for mass transfer. In one embodiment the rotors rotate independently with each rotor imparting rotation to the drive shaft independently through a slip clutch or similar device. Independent rotation is desired due to the increased control afforded thereby. In one embodiment the shaft intermediate, 18, comprises a shaft tachometer whereby the rate of rotation of the shaft can be monitored. A controller in the shaft intermediate can control a rotor controller, 22, for each rotor, 1, through communication linkages, 23. Each rotor controller, 22, comprises a suppressor, 24, capable of suppressing rotation of the rotor preferably by engaging physically with a surface of the rotor. The rotor controller can delay release of each rotor to insure complete mass transfer within the rotor and to optimise the efficiency of the system. The rotor controller and rotor suppressor are preferably controlled electrically yet mechanical control utilizing cam shafts is within the bounds of the present invention. Electrical control is preferred, in part, due to the increased control available through standard digital control methods and the lower number of moving parts required. The rotors in a rotor assembly can all be the same size or the size may vary for increased flexibility and control.

The rotors are preferably controlled based on system parameters and energy demand. In a preferred embodiment each rotor is coupled to a drive shaft with a slip clutch or similar device. The rotor can either be configured such that the rotation is near constant thereby reducing the necessity of a controller. It is more preferred that the controllers delay each rotor independently to insure complete mass transfer. Each rotor represents a non-diminishing potential energy source at full mass transfer. With multiple rotors the potential energy can be released on demand to respond to energy demand. Based on the teachings herein one of ordinary skill in the art could determine the optimum control based on the application.

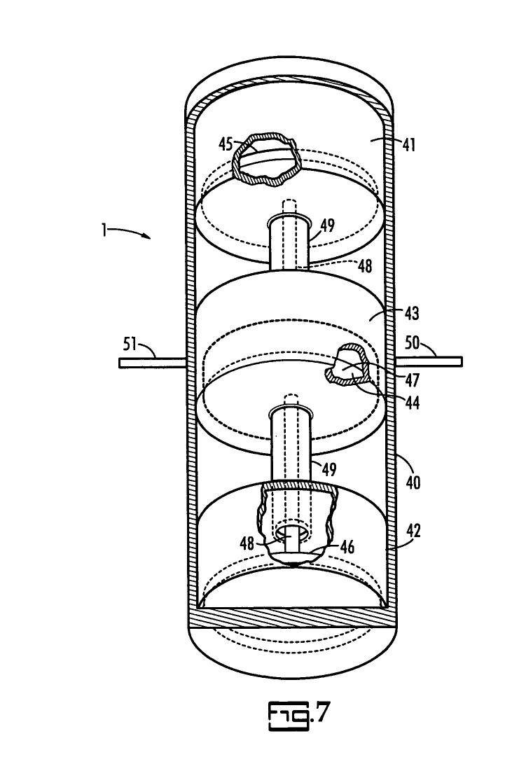

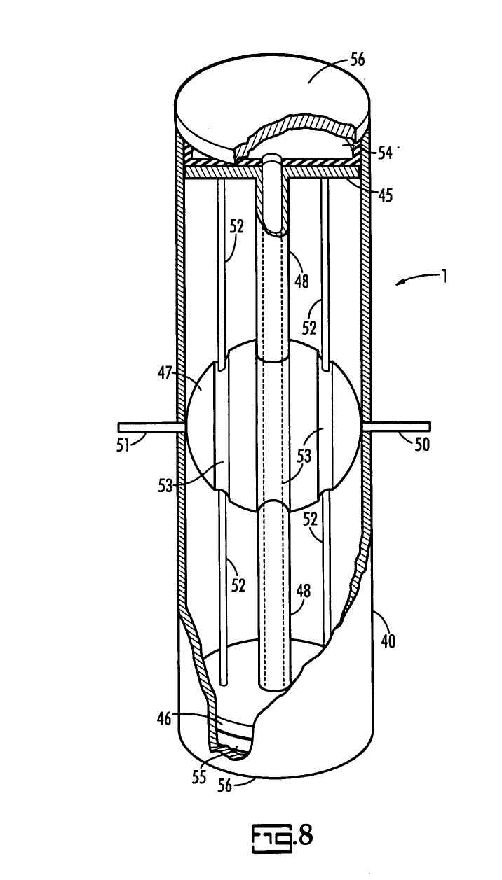

An embodiment of the present invention is provided in FIG. 5. In FIG. 5, the rotor, 1, comprises a first outer chamber, 4, and a second outer chamber, 5. Each outer chamber is contained within a collapsible bladder, 30. As used herein, the term “collapsible bladder” refers to a flexible material that readily expands and contracts in response to the amount of transfer fluid therein. Most preferably, the bladder has predetermined fold lines thereby allowing the bladder to consistently extend and contract. The outer chambers are in flow communication with each other through transport columns, 6. The inner chambers, 8 and 9, are in flow communication through the inner cavity, 31, of the shell, 2. Optional vents, 33, in the shell, 2, allow fluid to readily exchange with the environment. Vents are particularly suitable when the counter fluid is air. The shaft, 21, and slip clutch mechanism will be more fully described with reference to FIG. 6.

A suitable slip clutch is illustrated in FIG. 6. The drive shaft, 21, comprises at least one ratchet cam, 34. A pin, 35, reversibly received in a recess, 37, engages the drive face, 36, of the ratchet cam to rotate the shaft. If the shaft is rotating faster than the rotor or if the rotor is idle the cam face, 36, persuades the pin into the recess, 37, as it rotates and the drive shaft and rotor are decoupled. A spring, 38, persuades the pin to protrude to a drive face engaging position. The term “slip clutch”, as used herein, is used in accordance with the description common in the art. Particularly preferred is a reversibly engageable couple and more preferably the couple is unidirectional wherein rotation in one direction couples the two components while reversing one of the components decouples the rotation.

An embodiment of a rotor of the present invention is illustrated in cross-sectional, partial cut-away view in FIG. 7. In FIG. 7, the rotor, generally represented at 1, comprises an outer casing, 40. The shape of the outer casing is not particularly limiting. Cylindrical is a preferred shape due to the simplicity of manufacture. Secured to the interior of the outer casing are two working chambers, 41 and 42, and an optional centrally located guide chamber, 43. The working chambers are preferably of substantially identical volume. The piston, 44, comprises a pair of compression plates, 45 and 46, which force displacement fluid from one working chamber to the other in accordance with the operation of the rotor as set forth herein. A centrally located weight, 47, slides in the guide chamber, 43, in response to gravitational force as described previously. A transfer tube, 48, connects the working chambers and allows displacement fluid to traverse from one working chamber to the other in response to the lower chamber being compressed by the compression plate due to the force of gravity on the piston. The two compression plates and weight are connected one to the other preferably by the transfer tube. The guide chamber and that portion of each working chamber which is interior to the compression plate are preferably connected by tubes, 49. The tubes allow free flow of counter fluid between the inner portions of the working chamber and the guide chamber to avoid restricting travel of the piston due to counter fluid compression, turbulence, boundary flow restrictions or any condition which would cause the flow of the counter fluid to limit mass transfer. A drive shaft, 50, preferably attached to the outer casing, 40, couples to a generator as described previously. An idler axle, 51, parallel to the drive shaft provides a support for the rotor.

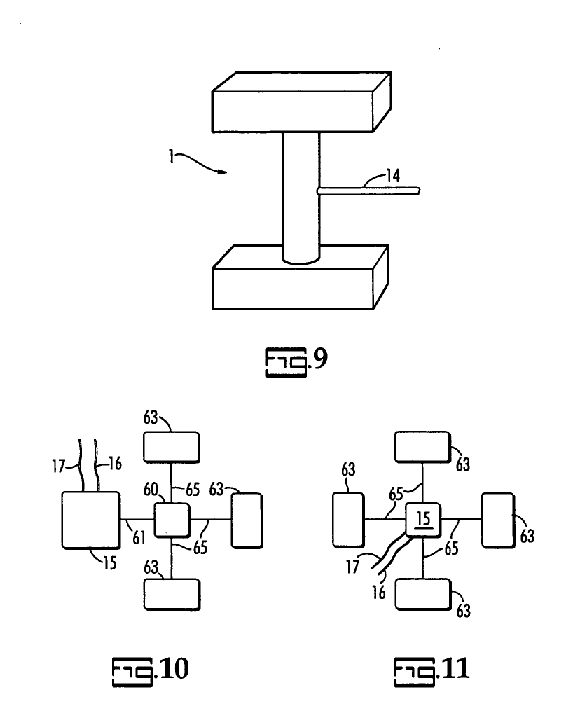

Another embodiment of the rotor is illustrated in cross-sectional view in FIG. 8. In FIG. 8, the rotor comprises an outer casing, 40. Interior to the outer casing is a piston comprising a pair of compression plates, 45 and 46, equidistant from an optional weight, 47. The compression plates and weight are preferably attached by a transfer tube, 48. Additional stabilizing rods, 52, may be employed for stability if necessary. The central weight, 47, comprises bleed devices, 53, such as exterior grooves or holes through the weight to avoid any resistance which could be caused by counter fluid. Bladders, 54 and 55, between each compression plate and the end cap, 56, form a continuous chamber with the transfer tube, 48, allowing displacement fluid to transfer therebetween. It would be apparent from the descriptions elsewhere herein that as one bladder is compressed the other bladder expands proportionally. The shape of the weight is not limiting. Shapes which minimize contact with the interior of the outer casing are preferred to decrease friction. A drive shaft, 50, and idler shaft, 51, allow the rotor to be rotatably suspended in bearings or similar friction reducing means as known in the art.

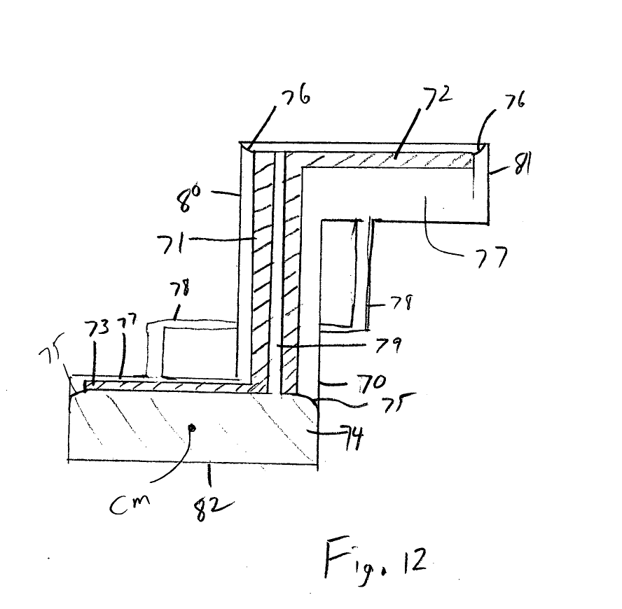

A preferred rotor is illustrated in FIG. 9. In FIG. 9, the rotor, 1, is elongated parallel to the drive shaft, 14. A rotor which is elongated parallel to the drive shaft is preferable since the amount of rotation required to have the center of balance sufficiently offset to initiate rotation is minimized. The longer, and narrower, the rotor the better up to the limit of restricting mass movement of the piston and fluids in a timely manner.

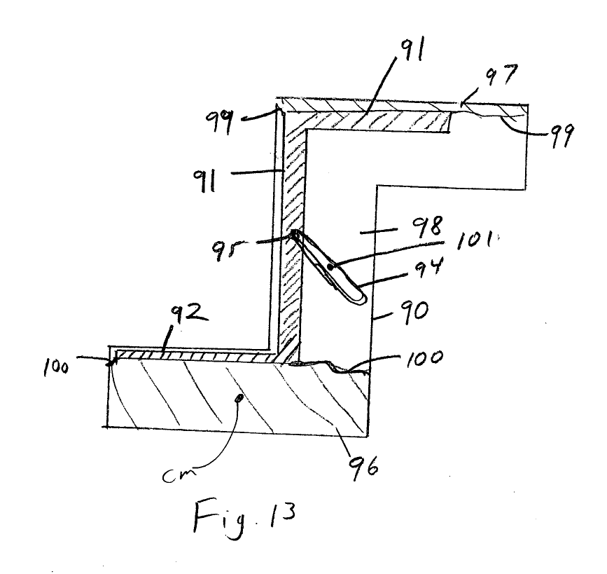

The rotor of the present invention can be used singularly, wherein a single rotor turns a generator, or in multiples wherein multiple rotors turn a generator. An embodiment of the present invention comprising multiple rotors is illustrated schematically in FIG. 10. In FIG. 10, a multiplicity of rotor assemblies, 63, each with a drive shaft, 65, attached thereto, is coupled to a coupler, 60. The coupler, 60, receives rotational energy from the rotor assemblies, and transfers the combined rotational energy to a single secondary driveshaft, 61, which is in turn coupled to a generator, 15. Another embodiment is provided in FIG. 11 wherein the generator receives rotational energy from multiple rotors. It is well within the skill of one of ordinary skill in the art to configure a coupler to multiple rotating shafts for a common shaft output. A rotor assembly may comprise one or more rotors.

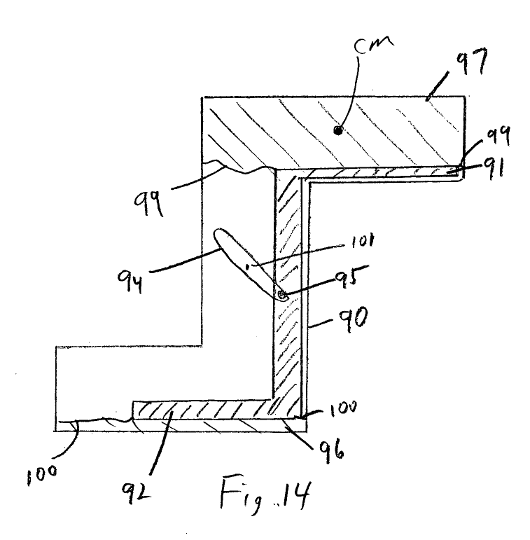

A particularly preferred embodiment of the invention is illustrated in FIG. 12. In FIG. 12, the rotor comprises a casing, 70. In this embodiment the casing comprises a central region, 80, and offset cavities, 81 and 82, wherein the volume of the offset cavities is at least displaced in opposite directions from a direction perpendicular to the rotational axis. Interior to the casing, 70, is a piston, 71. The piston comprises a first lobe, 72, and a second lobe, 73, wherein the first lobe and second lobe are displaced in opposite directions from the center of mass of the piston. A piston with offset lobes, coupled with a casing with offset cavities has proven to provide improved efficiency. Displacement fluid, 74, optionally contained in a bladder, 75, passes from the lower offset cavity, 82, to the upper offset cavity, 81, through a transfer tube, 79, as the piston drops. An optional counter fluid transfer tube, 78, can be employed to allow the counter fluid to transfer within the cavity, 77, of counter fluid. The counter fluid transfer tube can be interior to the casing or exterior to the casing. The counter fluid transfer tube is desirable to prohibit moisture and the like from entering the cavity while still allowing uninhibited transfer of counter fluid within the cavity.

A particular advantage of the embodiment illustrated in FIG. 12 is the enhancement provided by the offset lobes and offset cavities. The enhancement is provided by increasing the weight which is above the fulcrum and which is offset from the axis of the fulcrum. Through diligent research the inventor has determined that the further the center of mass is offset from the fulcrum the higher the energy output achieved for the rotor.

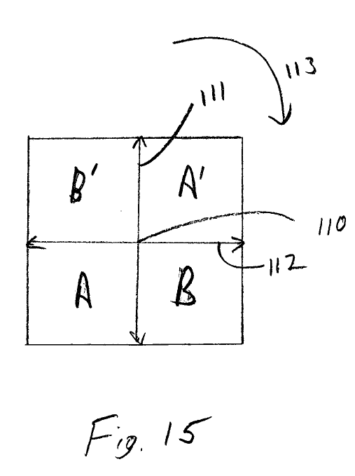

A particularly preferred embodiment is illustrated in FIGS. 13 and 14. FIG. 13 illustrates the embodiment after rotation due to gravity but prior to the piston moving downward to displace the fluid. FIG. 14 shows the same embodiment after the piston has moved downward but prior to the initiation of rotation.

In FIGS. 13 and 14 the casing, 90, comprises offset cavities as described supra. Inside the casing is a piston, 91, with opposing lobes, 91 and 92. A following cog, 95, on the piston follows a channel, 94, such that as the piston moves downward the piston also moves the center of mass from one side of the axis of rotation, illustrated at 101, to the other side of the axis of rotation. As the piston moves down it also translates thereby increasing the amount of weight which transfers in a direction which is not-parallel to gravity thereby increasing the weight of the rotor displaced to one side of the axis of rotation. The material in the bottom cavity, 96, is displaced into the top cavity, 97. Each cavity preferably has a seal, 99 and 100, which isolates the displacement fluid within the two cavities and transfer tube (not shown). Another advantage of the embodiment is that the displacement fluid center of mass is displaced in a direction which is not collinear with gravity. In FIG. 12, the center of mass of the displacement fluid, generally represented at CM, moves in a direction which is not collinear with and opposite to the force of gravity. The drive shaft would be attached substantially collinear with the axis of rotation. For the purposes of the present invention the center of mass is the point in the body or bodies at which the whole mass may be considered as concentrated.

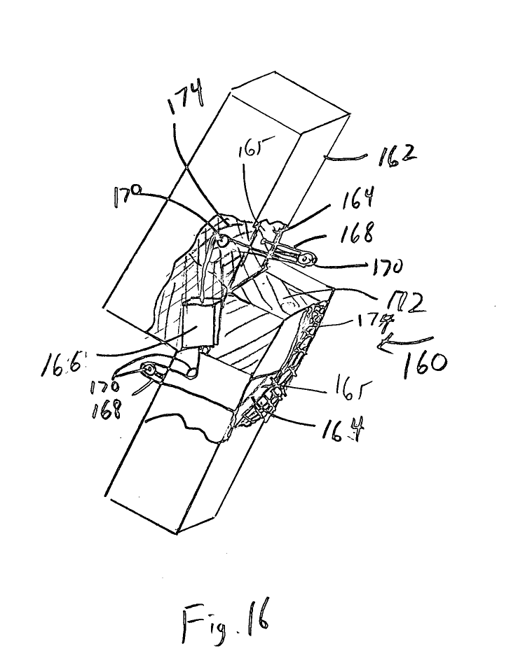

A particular advantage of the embodiment of FIGS. 13 and 14 is the ability to incorporate a mass transfer in a direction which is nonlinear relative to the direction of gravity. This is explained more fully with reference to FIG. 15. FIG. 15 is a schematic representation of the advantages of the present invention. In FIG. 15 the axis of rotation is indicated at 110 and vector 111 is parallel to the gravitational force. If weight of boxes A and B exceeds the weight of boxes A′ and B′ there will be no rotation as would be realized. As the piston moves down the weight of the counter liquid moves upward to the point where the weight of A′ and B′ exceeds the weight of A and B. As readily realized at the theoretical limit of A′ and B′ being exactly equal rotation requires input energy in accordance with the first law of thermodynamics. If it is desired for the device to rotate in the direction of the arrow, 113, it is desirable for box A′ to have a higher weight than box B′. The higher the weight difference the more momentum created as the device rotates. The device described in FIGS. 13 and 14 allow more weight to shift parallel to gravity, along vector 112, thereby increasing the weight in A′ over that in B′. Incorporating a translation allows the mass transfer to have a component which is parallel to gravity and a component which is perpendicular to gravity as depicted schematically in FIG. 15 as being preferentially from A to A′. By summation of the mass transfer the net movement of mass is in a direction which is non-linear relative to the force of gravity.

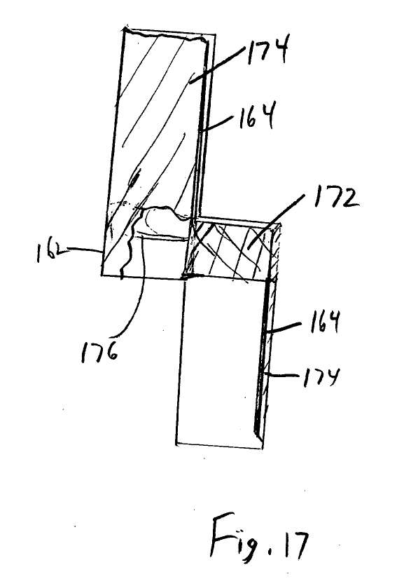

An embodiment of the present invention is illustrated in FIG. 16. The rotor of FIG. 16, generally referred to as 160, represents a particularly preferred embodiment. In the embodiment of FIG. 16, the piston, 164, is of minimal weight and a displacement weight, 166, moves in response to the gravitation pull thereby causing said piston to move by a displacement mechanism which will be more fully described. The movement of the piston causes displacement of the displacement fluid. In FIG. 16, the casing, 162, comprises chambers which are oppositely offset relative to the center as shown and previously described. The piston, 164 comprises lands, 165, which are drawn towards the wall of the casing to displace displacement fluid as will be more readily understood. Each land is attached to a connector, 172, which insures that the lands move in concert. The connector is can be cubic with open ends in the direction of travel to avoid air resistance. The particular shape of the connector, 172, however, is not limited and can include any configuration that connects the lands, 165, without restricting air flow. As illustrated the rotor is prior to rotation. Upper and lower bladders, 174, contain the fluid. In the configuration shown the displacement fluid is primarily contained in an upper bladder and the lower bladder (shown in cutaway view) is substantially depleted of displacement fluid. The displacement weight is at the lowest extent after having dropped due to the gravitational pull. The displacement weight is attached through a displacement mechanism to the piston. The displacement mechanism illustrated utilizes a collection of cables and pulleys, however, other mechanisms capable of coupling the movement of two elements in directions which is not co-linear could be used. A cable, 168, on either side of the displacement weight, and attached to the displacement weight, 166. The cable goes around a pair of idle rollers, 170, thereby translating the movement of the displacement weight into a substantially parallel displacement of the piston. The orientation of the rotor is preferably partially rotated in the direction of rotation since this provides an increase in energy. When the rotor rotates approximately 180° the displacement weight is now at the upper extent of its travel range and the upper bladder, 174, is in the position of the previous depleted bladder. Due to gravity the displacement weight, 166, moves downward thereby drawing the piston in a direction about perpendicular to the movement of the displacement weight which causes the displacement fluid to be pressed from the lower bladder into the upper bladder until the configuration of FIG. 16 is again reached.

A partial cross-sectional view of the embodiment of FIG. 16 is illustrated in FIG. 17 wherein the bladder, 174, is more readily visible as is the transport tube, 176. In FIG. 17, the lands are viewed on edge and the connector is viewed from the side such that the open front and back, to decrease air resistance, is not visible.

The function of the piston is to displace fluid from a lower chamber to the upper chamber. The weight of the piston, or pressure exerted on the piston by a displacement weight, must be sufficient to displace volume of displacement fluid and to overcome any friction associated with the displacement mechanism.

The displacement fluid and counter fluid are not limiting except that the total weight of displacement fluid displaced is higher than the weight of counter fluid displaced. Both the displacement fluid and the counter fluid are preferably selected from materials which flow well. Heavier displacement fluids are preferred. The fluid may include various ingredients known in the art including stabilizers, surfactants, etc. Particularly suitable displacement fluids include water, mercury, and low viscosity high density organic solvents. Water is the most preferred displacement fluid due to, among other things, cost and availability. Particularly suitable counter fluids are gases, particularly air.

The generator is any device suitable for converting rotational energy to a usable energy form. Particularly preferred generators produce electricity or pressure. Electrical generators are well known and further elaboration herein is not necessary. Pressure generators are known to include fluid pumps such as water pumps, hydraulic pumps, air pumps and the like wherein the moving fluid is further used to accomplish a task. An electrical generator is most preferred.

Bladders are not limited by their material of construction with the exception of the flexibility which must be sufficient for the bladder to expand and extract without hindering the mass transfer. The manner in which the bladder is attached is also not critical to the present invention.

Flow communication, in the context of the present invention, is specific to a mechanism for transferring fluid from one vicinity to the other. In general, the area containing fluid has a fixed volume within complimentary regions wherein one contracts concurrently with one expanding and the flow communication is a preferably fixed volume region therebetween.

The invention has been described with particular emphasis on the preferred embodiments. It would be realized from the teachings herein that other embodiments, alterations, and configurations could be employed without departing from the scope of the invention which is more specifically set forth in the claims which are appended hereto.

Claimed is:

1. A device for converting gravitational force to energy comprising:
a rotor with an axis of rotation comprising an upper portion and a lower portion and further comprising:
a casing;
a lower cavity and an upper cavity in flow communication with said lower cavity;
a piston comprising a first lobe and a second lobe wherein said first lobe and said second lobe are displaced in opposite directions from a center of mass and at opposite ends of said piston and wherein said piston is slidably received in said casing and between said lower cavity and said upper cavity wherein when said piston slides in said casing towards said lower cavity displacement fluid is forced from said lower cavity to said upper cavity thereby causing said upper cavity to be heavier than said lower cavity;
wherein said rotor can rotate on said axis of rotation such that said upper cavity becomes lower than said lower cavity to generate power.

2. The device of claim 1 comprising at least two rotors.

3. The device of claim 2 wherein said at least two rotors are coupled linearly.

4. The device of claim 2 wherein said at least two rotors are coupled to a coupler.

5. The device of claim 1 further comprising an electrical generator.

6. The device of claim 1 wherein said lower cavity comprises a first bladder and said upper cavity comprises a second bladder and said displacement fluid moves between said first bladder and said second bladder as said piston slides.

7. The device of claim 1 further comprising a first inner chamber and a second inner chamber in flow communication with said first inner chamber wherein said counter fluid flows between said first inner chamber and said second inner chamber in response to said piston sliding.

8. The device of claim 1 wherein said piston moves in a direction which is not collinear with the force of gravity.

9. The device of claim 8 wherein said piston comprises a cog.

10. The device of claim 9 wherein said cog is received in a channel.

11. A device for converting gravitational force to energy comprising:
a rotor with an axis of rotation wherein said rotor comprises a first end and a second end and further comprises:
a first cavity in said first end;
a second cavity in said second end wherein said second cavity is in flow communication with said first cavity;
a piston between said first cavity and said second cavity wherein when said piston slides in response to gravity towards said first end a displacement fluid exits said first cavity and enters said second cavity thereby causing said rotor to be heavier on said second end;
a pivot wherein said rotor can rotate on said pivot such that said second end rotates to a position lower than said first end in response to gravity;
wherein when said piston slides movement is in a direction which is not co-linear with gravity;
a shaft capable of rotating with said rotor; and
a generator coupled to said shaft.

12. The device of claim 11 wherein said piston comprises a first lobe, a second lobe and a center of mass.

13. The device of claim 12 wherein said fist lobe and said second lobe are displaced in opposite directions from said center of mass.

14. A rotor with an offset center of balance for converting gravitational force to rotational energy comprising:
a first end and a second end;
a first cavity in said first end;
a second cavity in said second end wherein said second cavity is in flow communication with said first cavity;
a central pivot point between said first end and said second end;
a piston between said first end and said second end wherein said piston moves between said first end and said second end said piston center of gravity and said rotor center of gravity moves in a direction which is not co-linear with the force of gravity; and
a shaft parallel to said central pivot.

15. A device for generating energy from gravitational pull comprising:
a casing comprising:
a rotational axis a first offset cavity;
a second offset cavity wherein said first offset cavity and said second offset cavity are offset separately relative to said rotational axis;
a piston slidably attached inside said casing and capable of sliding due to gravity;
a displacement fluid capable of moving between said first offset cavity and said second offset cavity as said piston slides within said casing.

16. The device of claim 15 wherein said piston slides in a direction which is non-linear with respect to said gravitational pull.

17. The device of claim 16 wherein said piston has opposing lobes.

18. A rotor for converting gravitational force to rotational energy comprising:
a first end and a second end;
a first cavity in said first end;
a second cavity in said second end wherein said second cavity is in flow communication with said first cavity;
a displacement fluid selectively in said first cavity or said second cavity;
a central pivot point between said first end and said second end; and
a piston wherein when said piston moves in response to the force of gravity a center of mass of said displacement fluid moves from said first cavity to second cavity a direction which is not co-linear with said force of gravity.

19. The rotor of claim 18 wherein when said piston moves a center of mass of said piston moves in a direction which is not co-linear with said force of gravity.

20. The rotor of claim 18 further comprising a displacement weight which moves towards said force of gravity and causes said piston to move.

21. The rotor of claim 20 wherein said displacement weight and said piston move in directions which are not co-linear.
